(19) United States
(12) Patent Application Publication
(10) Pub. No.: US 2009/0184695 A1
(43) Pub. Date: Jul. 23, 2009

(54) METHOD AND SYSTEM FOR RMS COMPUTATION ON DIGITIZED SAMPLES

(75) Inventor: Adam Mocarski, San Diego, CA (US)

Correspondence Address: KNOBBE MARTENS OLSON & BEAR LLP, 2040 MAIN STREET, FOURTEENTH FLOOR, IRVINE, CA, 92614, US

(73) Assignee: Programmable Division of Xantrex Technology, Inc., San Diego, CA (US)

(21) Appl. No.: 12/028,739

(22) Filed: Feb. 8, 2008

Related U.S. Application Data
(60) Provisional application No. 61/022,256, filed on Jan. 18, 2008.

(51) Int. Cl. G06F 17/18; G05F 1/10

(52) U.S. Cl. 323/234; 702/179

(57) ABSTRACT

A system and method for computing a Root Mean Square (RMS) value of digitized samples is disclosed. Discrete digital representations of a continuous analog electrical signal are produced. The discrete digital representations are received by a digital computation module, wherein the digital computation module is configured to perform a division operation and a square root operation for the RMS computation in one combined algorithm.

### CROSS-REFERENCE TO RELATED APPLICATIONS

This application claims priority to U.S. Provisional Application No. 61/022,256 filed Jan. 18, 2008.

### BACKGROUND OF THE INVENTION

1. Field of the Invention

The present invention relates generally to the field of digital signal processing, and more particularly, to improved methods and systems for performing root-mean-square (RMS) computation on digitized samples in a digital computation module.

2. Description of the Related Art

The Root-Mean-Square (RMS) value of a given waveform is calculated by integrating the square of the waveform over an integer number of cycles, dividing the result by the time period over which the integral is performed, and then finding the square root of the quotient. For a waveform that is sampled into a series of discrete data values, the RMS value is found by summing the squares of a series of data points obtained over an integer number of cycles, dividing the sum by the number of samples in the sum, and then finding the square root of the quotient.

Root-mean-square (RMS) computations for digitized samples of waveforms are performed using a variety of algorithms. Regardless of the algorithm used, all RMS computations require division and square root operations following the construction of the sum of squared data points. Conventionally, the division and square root operations are done in two separate steps. For example, in a software implementation of the RMS computation, these two steps are typically performed by sequentially calling two separate subroutines, a division subroutine followed by a square root subroutine. Alternatively, in a digital hardware implementation, these two steps are performed by two separate logic circuits, one for the division operation and one for the square root operation.

### SUMMARY OF THE INVENTION

The system, method, and devices of the invention each have several aspects, no single one of which is solely responsible for its desirable attributes. Without limiting the scope of this invention as expressed by the claims which follow, its more prominent features will now be discussed briefly.

In one embodiment, the invention comprises a system for computing a Root Mean Square (RMS) value on digitized samples. The system comprises an analog to digital converter (ADC) configured to produce discrete digital representations of an analog signal; and a digital computation module in data communication with the ADC. The digital computation module is configured to receive the digital representations and compute an RMS value of the digital representations, wherein a division operation and a square root operation for the RMS computation are performed in one combined algorithm. In addition, a memory in data communication with the digital computation module is configured to receive and store the computed RMS value.

In another embodiment, a method of computing a Root Mean Square (RMS) value of digitized samples comprises producing discrete digital representations of an analog electrical signal, and computing an RMS value of the digital representations, wherein a division operation and a square root operation for the RMS computation are performed in one combined algorithm, and outputting the RMS value.

In another embodiment, a system for computing a Root Mean Square (RMS) value of digitized samples comprises means for producing discrete digital representations of an analog electrical signal; means for computing an RMS value of the digital representations, wherein a division operation and a square root operation for the RMS computation are performed in one combined algorithm; and means for storing the computed RMS value.

In another embodiment, a method of computing a Root Mean Square (RMS) value of digitized samples comprises storing a total number of a plurality of digital samples as a variable D; storing a sum of squares of the plurality of digital samples as a variable N; using an iterative algorithm to construct a variable x having a square that is less than N/D. The iterative algorithm comprises shifting the next two upper bits of N into a remainder variable R, checking for maintenance of an invariant defined by values of x, R, and D, and shifting in “1” or “0” into x depending on the result of the invariant maintenance checking.

In another embodiment, a system for computing a Root Mean Square (RMS) value of digitized samples comprises a first memory storing a variable D representing a total number of a plurality of digital samples, a second memory storing a variable N representing a sum of squares of the plurality of digital samples, a third memory storing a current remainder variable (R), and a fourth memory storing a current floor integer variable (x). Also provided are a first shift register configured to receive the current R from the third memory and generate a shifted R by shifting in the next two upper bits of N, a comparison circuit configured to receive the shifted R from the first shifted register and a function B involving D and the current x and make a comparison between the shifted R and B. Also provided is a second shifter register configured to receive the current x and generate a shifted x by shifting in “1” or “0” depending at least in part on the result of the comparison.

In another embodiment, a power supply comprises power hardware having an AC power output configured for coupling to a load impedance, the AC power output configured to provide an AC output voltage and an AC output current to the load impedance, one or more output parameter sensors, one or more analog to digital converters configured to produce digital representations of one or more sensed output parameters; and a digital feedback loop including a digital computation module configured to receive the digital representations and compute an RMS value of the digital representations, wherein the digital computation module is configured to perform a division operation and a square root operation for the RMS computation in one combined algorithm.

In another embodiment, a method of controlling an AC power supply comprises sensing an output parameter, generating digital representations of the sensed output parameter, generating a digital control signal at least in part by computing a Root Mean Square (RMS) value of the digital representations, wherein a division operation and a square root operation for the RMS computation are performed in one combined algorithm, and regulating one or both of the AC output voltage and the AC output current using the digital control signal.

### BRIEF DESCRIPTION OF THE DRAWINGS

FIG. 1 is a block diagram illustrating the power supply with digital feedback loops incorporating unified RMS computation algorithm according to certain embodiments.

FIG. 2 is a schematic block diagram illustrating the digital feedback loop that incorporates the unified RMS computation algorithm according to certain embodiments.

FIG. 3 is a flowchart illustrating an example of an iterative process for constructing the integer RMS value in the x array using the unified RMS computation algorithm according to certain embodiments.

FIG. 4 is a schematic diagram illustrating an example of a logic circuit implementing the unified RMS computation according to certain embodiments.

### DETAILED DESCRIPTION OF THE PREFERRED EMBODIMENT

While various embodiments of the invention are described below, they are to be construed as illustrative and not restrictive in character. All changes and modifications that are within the understanding of a person of ordinary skill in the art are desired to be protected. For example, a person of ordinary skill in the art would readily understand that some of the functional blocks in the figures illustrating various embodiments may be implemented by software or by hardware, or by a combination thereof.

Many digital signal processing applications require performing RMS computations on digitized analog signals. In some cases, RMS computations performed for measurement and/or monitoring purposes, with the result output visually to a user or operator on a display or other output apparatus. In other applications, control loops use an RMS value to regulate one or more system parameters. One control loop example is provided by U.S. patent application Ser. No. 11/540,938 (“The '938 Application”). This document discloses a power supply with a digital feedback control loop in which RMS values of digitized voltage and current samples are computed and used to control AC voltage and/or current outputs. To achieve a fast response time for the feedback loop, a new RMS computation is performed with every new digitized sample. Applications such as this would benefit from efficient and fast RMS computation algorithms.

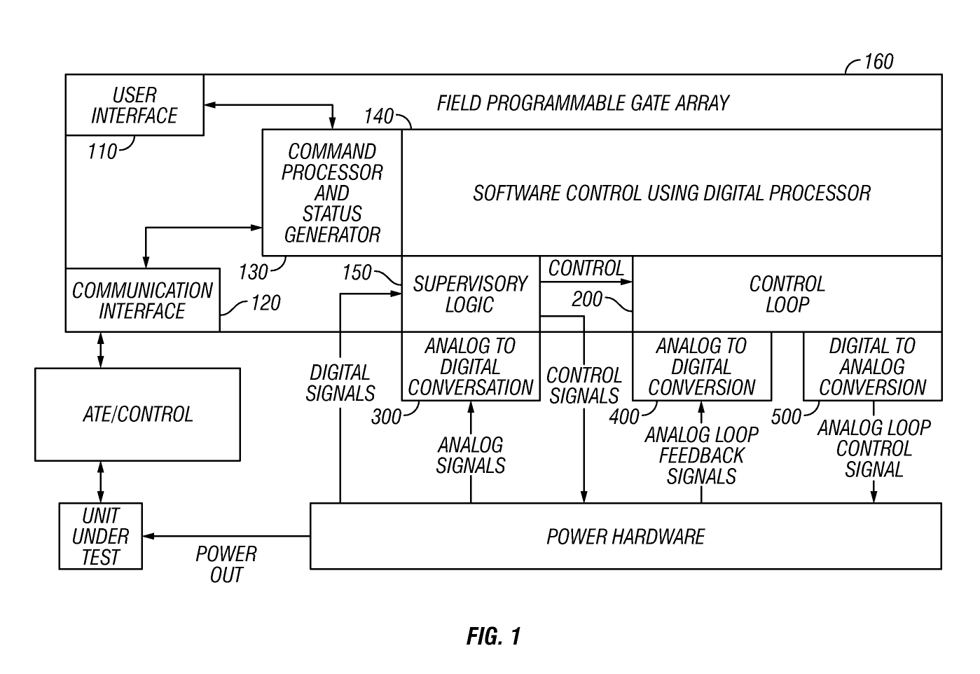

FIG. 1 shows an example of a power supply having a digital control in which the RMS computation is performed. The power supply comprises a power supply digital control 160 and power hardware 600. The power supply digital control 160 may comprise a user interface 110, a communication interface 120, a command processor/status generator 130, a digital processor for running control software, supervisory logic 150, and a control loop 200, which in a preferred embodiment are all implemented in a field programmable gate array. The power supply digital control further comprises analog to digital and digital to analog data converters. The data converters may comprise a first analog-to-digial converter (ADC) unit 170, a second ADC unit 180, and a digital-to-analog converter (DAC) unit 190.

In operation, the command process/status generator 130 receives programmable values including a pre-set RMS voltage (Vₛₑₜ) and/or a pre-set RMS current (Iₛₑₜ) and/or one or more parameters defining desired output waveform having a frequency (Fₛₑₜ) through the user interface 110 or the communication interface 120.

The control loop 200 receives the pre-set voltage amplitude, the pre-set current amplitude, and the digital feedback signals sent by the power hardware 600 and converted by the second ADC unit 180. The control loop generates a digital control signal which gets converted into an analog control signal by the DAC unit 190. The power hardware 600 receives the analog control signal and its output is regulated in accordance with this signal.

The power supply digital control is configured to provide a control signal that causes the power hardware to operate at any of a wide variety of programmed outputs. This is done by selectively employing digital feedback loops, including one or more RMS feedback loops, inside the control loop 200 as will be described in more detail below.

FIG. 1 illustrates the digital control and processing as implemented in combinatorial and sequential logic, one example of which is a field programmable gate array, and this is one possible implementation. It will be appreciated that a wide variety of implementations are possible. The digital functions may, for example, be implemented in firmware executed by a microprocessor or digital signal processor. Discrete logic hardware may also be utilized for some or all functions. In addition, it will be appreciated that some of the functions described below can be performed in the analog domain. As used herein, the term “digital feedback loop” refers to a feedback regulation system where at least some, but not necessarily all, of the processing performed during loop operation is done with digital signal processing techniques. It is generally advantageous, however, to perform most or all of the control loop functions in the digital domain.

The AC power supplies described herein have a variety of applications. For example, they are often used to provide well regulated input power to electrically powered appliances and equipment being performance tested. Input voltages, AC waveform shapes, frequency, and the like can be user controlled to test appliance performance under a variety of input power conditions.

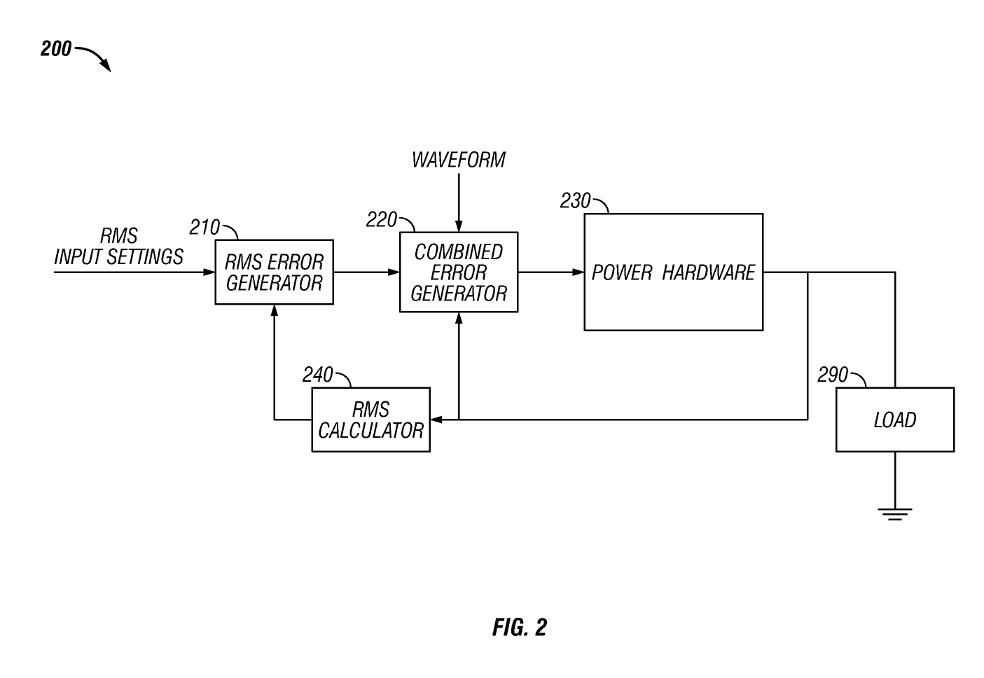

FIG. 2 is a simplified schematic block diagram illustrating a digital feedback loop 200 which can advantageously incorporate embodiments of the invention. The digital feedback loop comprises an RMS error generator 210, a combined error generator 220, power hardware 230, an RMS calculator 240, and an A/D converter 250. The AC output, e.g., a voltage or current (V/I), of the power hardware 230 is delivered to an external load 290.

The digital control loop 200 comprises two feedback loops: an instantaneous feedback loop and an RMS feedback loop. The instantaneous feedback loop is for generating an instantaneous voltage or current (V/I) error, while the RMS feedback loop is for generating an RMS V/I error.

The feedback loop of the example power supply takes analog signals from voltage and/or current sensors on the power supply output and generates discrete digital representations of the analog signals. The RMS calculator 240 performs RMS computations on the discrete digital representations. The RMS value generated by the RMS calculator 240 is fed into the RMS error generator 210, which takes the RMS V/I value and subtracts from it a user provided RMS input setting to generate an RMS error signal. The combined error generator 220 computes an instantaneous error signal to output to the power hardware 230. Additional details of one embodiment of a power supply feedback loop are described in the '938 Application and not repeated here.

The conventional calculation for RMS values of a sampled signal involves the following:

RMS(s)=SQRT (Σ_{i=1 to n}sᵢ²/n) 1)

Equation 1 above sums up the squares of the sample values s for the signal being regulated over one or more complete cycles of the AC waveform, whether that is voltage or current, and then divides the sum of squares by the number of samples n in the sum, and finally takes the square root to result in the root-mean-squared (RMS) value for the sampled signal. If the value computed in this way is used for error generation and regulation against a desired RMS setpoint, the RMS control loop must wait until the calculation is complete before it gets a new RMS value. For a periodic signal, this means that the RMS control loop must wait up to one full fundamental period before it is given a new value to produce a new control value for the power hardware.

To reduce delays, embodiments of the invention may use either of the following algorithms represented by the following two equations for computation of a RMS value for a sampled signal:

RMS(s)=SQRT (((Σ_{i=k to k+n-1}sᵢ²)+sₖ₊ₙ²−Sₖ²)/n) 2)

RMS(s)=SQRT (((Σ_{i=k to k+n-1}sᵢ²)−sₖ²+sₖ₊ₙ²)/n) 3)

Equation 2 represents one version of the improved no-delay approach. Equation 3 represents another version of the improved no-delay approach. For either approach, the number of samples in the sum is still n, but Equation 2 forms a sum with n+1 samples then subtracts the oldest sample from the n+1 sampled sum to result in a sum with n samples. To perform either of these algorithms the hardware stores the squares of the last n samples in a ring buffer, and stores a sum of these values from the square of sample k to the square of sample k+n−1, where n samples are taken over the course of one complete cycle of the AC waveform. To produce an updated RMS value for use in the control loop, the square of sample k+n is added to the sum, and the square of the oldest sample k is subtracted from the sum. The square of the newest sample k+n is stored in the ring buffer in place of the square of the oldest sample k. Equation 3 differs from Equation 2 in the order that this addition and subtraction are done; the ring buffer is still used in Equation 3 to keep track of the last n samples. The approaches of Equations 2 and 3 mean that the RMS control loop always has the latest RMS value no more than one sample old, and not one whole fundamental period old, thereby minimizing or virtually eliminating delay for the RMS control loop. Thus the RMS control loop will be much more responsive to changes in load and output conditions of the power supply.

Conventionally, RMS computations, such Equations 1, 2, and 3, involved two separate division and square root operations performed after the squaring and summing operations. The method described herein represents improvements to the conventional RMS computation method by combining division and square root operations into one unified RMS computation algorithm.

Square root operations and division operations on binary numbers are performed with an iterative series of bit shifts and arithmetic operations such as addition, subtraction, and multiplication. It is one aspect of the invention that an algorithm for combining both a square root and division operation into a common set of iterative steps has been devised. This allows the RMS computation to be performed with a smaller and faster logic circuit than the conventional series of division and square root operations.

An iterative process for RMS calculation has been devised by noting that the RMS calculation x=(N/D)^{1/2} for integer x, D, and N involves finding values for x and R that satisfy the equation:

x²D+R=N 4)

where R is a remainder variable introduced because N/D need not be a perfect square. An iterative algorithm has been devised to construct x by successively shifting two new bits of N into a newly defined variable n and updating values for x and R with each iteration while simultaneously guaranteeing at each iteration that:

x²D+R=n 5)

At an i^{th} iteration, the n vector holds 2i upper bits of N so far shifted in. For example, suppose N=1721, which is [011010111101]. For the first (i=0) iteration, n=[01]. For the second (i=1) iteration, n=[0110]. For the third (i=2) iteration, n=[011010]. Finally, for the 6^{th} (i=5) iteration, n=[011010111101], which is N. If the Equation 5) is satisfied at each step of the iteration, it will be satisfied at the final iteration when n=N, at which point the final value for x will be a solution to the Equation 4). It may be noted, however, that the Equation 4) does not produce a unique value for x. For example, x=0 and R=N is a solution. Thus, an iterative shifting of bits of N into both n and R while continually shifting zeros into x would maintain the equality at all steps of the iteration. The desired solution for x is the one with maximum x and minimum R. This constraint can be introduced by insuring that the square of x+1 exceeds N/D:

(x+1)²>N/D 6)

Substituting x²D+R for N from Equation 4) into Equation 6) leads to the relation:

(2x+1)D>R 7)

At all steps of the iteration, therefore, we require:

x²D+R=n AND (2x+1)D>R, 8)

which defines the loop invariant for the iterative operation.

The following iterative algorithm satisfies these relationships at each step:

Perform iteratively for i=0 to ½[/bitwidth of N]−1:
set initial conditions R=0, x=0 at i=0;
update R by setting it to 4R+2N[N.bitwidth-2i−1]+N[N.bitwidth-2i−2]; (next two upper bits of N left shifted into R, where lowest bit of N is bit 0, N.bitwidth is total number of bits in N)

set B=4xD+D;

If R is equal to or larger than B then,
set x [symbol] 2x+1; (left shift 1 into x)
set R [symbol] R−B;

If R is less than B;
set x [symbol] 2x; (left shift 0 into x)

increment i.

For example, if N is the 8 bit number 255, which is [11111111], and D is 15, the desired solution is 4, as this is the largest integer that is less than or equal to the square root of 255/15. The above algorithm can be seen to produce this result. For the first (i=0) iteration, R is 3 and B is 15. Since R is smaller than B, x is set to 2x which is still 0 and R remains 3. For the second iteration, R is 15 and B is 15, so that x is set to 2x+1, which is 1 and a new value for R is assigned by subtracting 15 such that R=15−15=0. For the third iteration, R is 3 and B is 75, so that x becomes 2x which is 2 and R=3. For the fourth and last iteration, R is 15 and B is 135, so that x becomes 2x, which is 4, and R=15, which is the desired solution.

The iterative algorithm described above can be cast into a more programmatic format as follows:

```
Function Unified_Div_Sqrt1;
        x, R, i:= 0, 0, 0;
        while (2 i ≠ N.bitwidth)
        {
              j := N.bitwidth − 2i−1; (lowest bit of N is bit 0,
        N.bitwidth is total number of bits in N)
              R := 4R + 2N[j] + N[j−1];
              B: 4xD + D;
              if (R >= B)
              {
                      R := R − B;
                      x := 2x + 1;
              }
              else
              {
                      x := 2x;
              }
              i := i + 1;
        },
```

where,

x is a bit array for constructing an integer representation of the RMS value being sought through loop operations,

“i” is an index representing iterations employed in constructing the x array, and

R is a remainder variable introduced to account for the fact that x represents a floor integer approximation to (N/D)^{1/2}.

The fact that the invariant conditions x²D+R=n and (2x+1)D>R (Invariant Equation 8) are satisfied at each step of the above iterative process can be proven as follows.

For the iterative loop, there can be two cases: either a 1 is shifted into x or a 0 is shifted into x. Below, both cases are checked for the maintenance of Invariant Equation 8 with the corresponding update to the remainder variable R.

A) x:=2x+1 case

If a 1 is shifted into x, and the next 2 bits of N (N[j] and N[j−1]) are shifted into R, and the assignments for x and R are made, Invariant Equation 8 takes the following form:

(2x+1)²D+4R+2N[j]+N[j=1]−4xD−D=4n+2N[j]+N[j −1] AND (2(2x+1))D>4R+2N[j]+N[j−1]−4xD−D 9)

After some algebraic manipulations, Equation 9 can be re-written in the following simpler form:

4x²D+4R=4n AND 8xD+3D>4R+2N[j]+N[j−1] 10)

The left conjunction is true since it is just the equation 5) with both sides of the equation multiplied by 4. The right conjunction is true from the initial conditions.
B) x :=2x case

If a 0 is shifted into x, and the next 2 bits of N are shifted into R, and the assignments for x and R are made, Invariant Equation 8 takes the following form:

(1x)²D+4R+2N[j]+N[j−1]=4n2N[j]+N[j]+N[j−1] AND (4x+1)D>4R+2N[j]+N[−1] 11)

Again, after some algebraic manipulations, Equation 11 can be re-written in the following simpler form:

4x²D+4R=4n AND 4xD+D>4R+2N[j]+N[j−1] 12)

Again the left conjunction is true because it is just Equation 5 multiplied by 4 on both sides. The right conjunction also holds since 2 bit-left-shifts cannot change the inequality no matter what bits are shifted in.

With one exception, the operations in the above algorithm can be performed on binary numbers with only bit shifts for multiplying by 2 or 4, and subtraction and addition operations. The one exception is that the value for B requires a multiplication of × times D with each iteration. This multiplication operation can be removed by introducing a new variable t as follows:

Perform iteratively for i=0 to ½[bitwidth of N]−1:

set initial conditions R=0, x=0, t=0 at i=0;

update R by setting R=4R+2N[N.bitwidth-2i−1]+N[N.bitwidth-2i−2]; (next two bits of N left shifted into R, where lowest bit of N is bit 0, N.bitwidth is total number of bits in N)

set B=4t+D;

If R is equal to or larger than B, then
set x [symbol] 2x+1;
set R [symbol] R−B;
set t [symbol] 2t+D;

If R is less than B, then,
set x [symbol] 2x;
set t [symbol] 2t;

increment i;

With this revision, both t and B can be computed with shifts and additions only, with B of this algorithm having the same value as the first algorithm above at each iteration.

As before, the iterative algorithm described above with the new variable t above can be cast into the following programmatic format:

```
Function Unified_Div_Sqrt2;
        x, R, t, i:= 0, 0, 0,0;
        while (2 i ≠ N.bitwidth)
        {
              j := N.bitwidth − 2i−1; (lowest bit of N is bit 0,
        N.bitwidth is total number of bits in N)
              R := 4R + 2N[j] + N[j−1];
              B: = 4t + D;
              if (R >= B)
              {
                      R := R − B;
                      x := 2x + 1;
                      t := 2t + D;
              }
              else
              {
                      x := 2x;
                      t := 2t;
              }
              i := i + 1;
        }
```

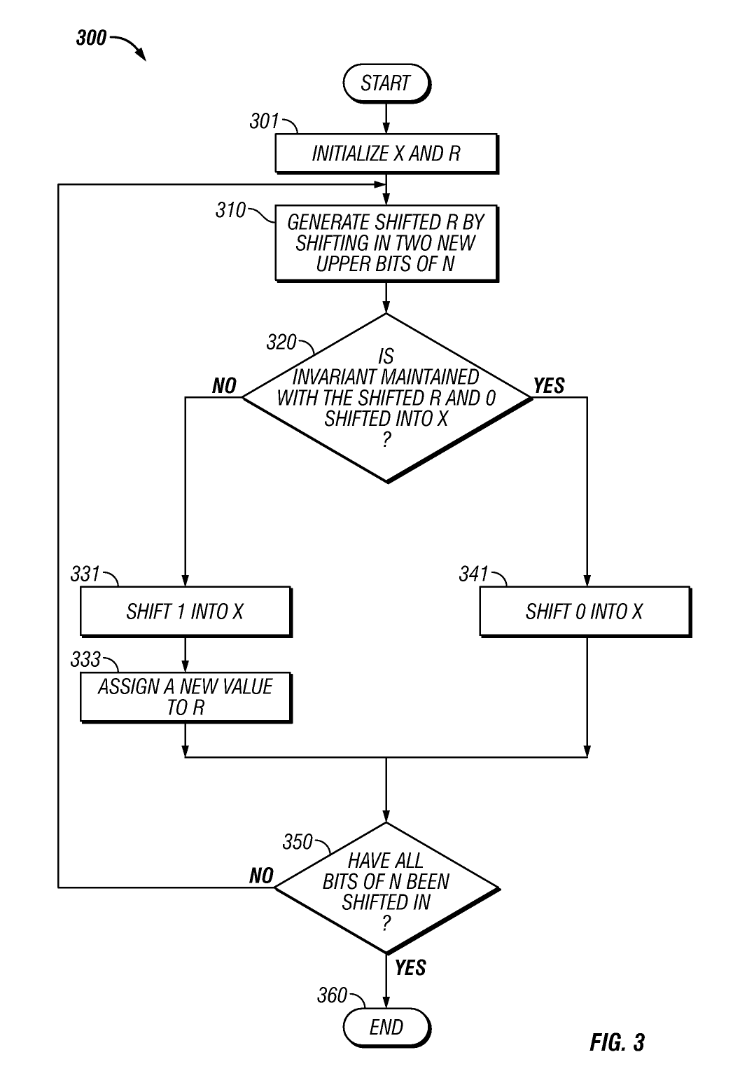

FIG. 3 is a flowchart illustrating an example of an iterative process for constructing the integer RMS value in the x array using the unified RMS computation algorithm according to certain embodiments. The process 300 starts at state 301, where the x and R are initialized. The process then moves to state 310, where a shifted R is generated by shifting in next two upper bits of N into R, e.g., R=4R+2N[N.bitwidth-2i]+N[N.bitwidth-2i−1]. The process then moves to state 320, where it is queried whether an invariant condition with the updated R can be satisfied if 0 is shifted into x. For example, is the invariant condition satisfied if the shifted R is less than B, where B=4xD+D. If the answer is YES, 0 is shifted into x at state 331. On the other hand, if the answer is NO, 1 is shifted into x at state 341 and a new remainder value is assigned to R at state 333. After either branch, the process moves to state 350, where it is queried whether all bits of N have been shifted into R. If the answer is YES, the process ends at state 360. If the answer is NO, the process loops back to state 310, where the next two upper bits of N are shifted into R and either 1 or 0 is shifted into x as described above. This iterative process repeats until, all bits of N have been shifted into R. At this point, x2D+R=N is uniquely satisfied, with the desired integer RMS value constructed in the x variable. Various computation variables x, n, R, and D can be bit arrays in case of software implementation or data registers in case of hardware implementation such as described below.

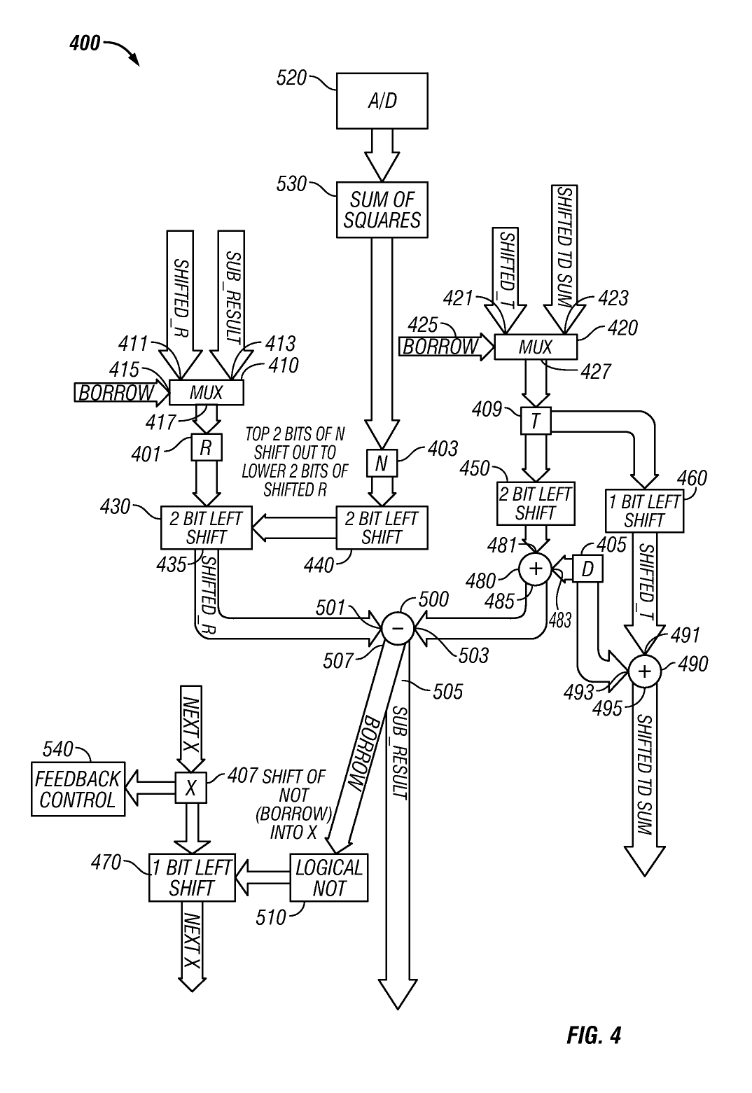

It will be apparent to a person skilled in art that the unified RMS computation algorithm described above lends itself to an efficient hardware logic implementation. Because all multiplier constants are powers of 2, various operations of the unified algorithm can be implemented with a few simple logic components such as shifters, adders, multiplexers, and the like. FIG. 4 is a block diagram of an example of a logic circuit 400 that may be used to implement a unified RMS computation algorithm. The example logic circuit 400 comprises a plurality of data registers 401, 403, 405, 407, 409, a plurality of multiplexers (mux's) 410, 420, a plurality of shift registers 430, 440, 450, 460, 470, a plurality of adders 480, 490, a subtractor 500, and a bit inverter 510. The data registers comprise a R register 401, a N register 403, a D register 405, an x register 407, and a t register 409. The mux's comprise a first mux 410 and a second mux 420. The first mux 410 comprises a first input 411, a second input 413, a select input 415, and an output 417. The second mux 420 comprises a first input 421, a second input 423, a select input 425, and an output 427. The shift registers comprise a first shift register 430, a second shift register 440, a third shift register 450, a fourth shift register 460, and a fifth shift register 470. The adders comprise a first adder 480 and a second adder 490. The first adder 480 comprises a first input 481, a second input 483, and a sum output 485. The second adder 490 comprises a first input 491, a second input 493, and a sum output 495. The subtractor 500 comprises input 501, input 503, a difference output 505, and a borrow output 507.

The first input 411 of the first mux 410 is connected to the output of the 435 of the first shift register 430 and receives a shifted R value which will be described below with reference to the first shift register. The second input 413 of the first mux 410 is connected to the output 505 of the subtractor 501 and receives a subtraction result which will be described below with reference to the subtractor. The select input 415 of the first mux 410 is connected to the borrow output 507 of the subtractor 500 and receives a borrow value, indicating whether the result of the subtraction by the subtractor is negative. The first mux 410 selects either the shifted R value or the subtraction result depending on the borrow value and sends the selected output to the input of the R register 401. The output of the R register 401 is connected to the first input of the first shift register 430. The input of the second shift register 440 is connected to the N register 403 and receives the stored value of N. The input of the N register 403 is connected to the output of a square-and-sum module 530 configured to generate a sum of squares of digitized sample values. The input of the square-and-sum module is connected to the output of an A/D converter 520 that digitizes an analog electrical signal. The second shift register 440 performs a 2-bit-left-shift operation on N and shifts out top 2 bits of N to the second input 433 of the first shift register 430. The first shift register 430 performs a 2-bit-left-shift operation on R and shifts in next 2 bits of N shifted out from the second shift register 440. The first shift register 430 then outputs the 2-bit shifted R with its lower 2 bits filled with next 2 bits of N to the input 501 of the subtractor 500.

The first input 421 of the second mux 420 is connected to the output of the fourth shift register 460 and receives a shifted t value, which will be described below with reference to the fourth shift register 460. The second input 423 of the second mux 420 is connected to the sum output 495 of the second adder 490 and receives a shifted tD sum, which will be described below with reference to the second adder. As with the first mux 410, the select input 425 of the second mux 420 is connected to the borrow output 507 of the subtractor 500. The second mux 420 then selects either the shifted t value or the shifted tD sum depending on the borrow value and sends the selected value to the input of the t register 409. The output of the t register 409 is connected to the input of the third shift register 450 and also the input of the fourth shift register 460. The third shift register 450 performs a 2-bit left shift operation on t and output the result to the first input 481 of the first adder 480. The second input 483 of the first adder 480 is connected to the output of the D register 405 and receives the stored value of D. The subtractor 500 receives the output 485 of the first adder 480 at its input 503 and subtracts it from the shifted R value received from first shift register 430 and produces the subtraction result that is fed into the second input 413 of the first mux 410 as described above.

The fourth shift register 460 performs a 1-bit left shift operation on the value of t received from the t register 409 and outputs the shifted t to the first input 491 of the second adder 490. The second input 493 of the second adder 490 is connected to the output of the D register 405 and receives the stored value of D. The second adder 490 adds the shifted t value and the D value and produces the shifted tD sum which is fed into the second input 423 of the second mux 420 as described above. The fifth shift register 470 receives the value of x stored in the x register 407 and performs a 1-bit-left-operation on x and shifts in the output of the bit inverter 510 which is an inverted value of the borrow value described above. The output 475 of the fourth shift register 470, which is now a 1-bit shifted x with the lowest 1 bit filled with the inverted borrow value, is connected to the input of the x register which receives and stores the updated x value.

In operation, the data registers for R and t are initialized to zero, and the registers for N and D are set to their respective data values. For example, the N register 403 receives a new sum of squares of digitized samples from the square-and-sum module 530; and the D register 405 receives the total number of digitized samples being squared and summed With each iteration, the shifted R value (R=4R+2N[j]+N[j]) described above is produced by the shift register 430, and the value B described above is produced by adding the output of shift register 450 and the D register 405. Subtractor 500 performs the test to determine whether the shifted R is equal to or larger than B by producing a borrow bit if the shifted R is less than B. If the borrow bit is set, then the shifted R is less than B, and a zero is shifted into x by shifting the inverse of the borrow bit into x. If the borrow bit is not set, then the shifted R is equal to or greater than B, and a one is shifted into x when the inverse of the borrow bit is shifted into x. The borrow bit also controls which of the multiplexer inputs is used to update the R register 401 and the t register 409. If the borrow bit is set, the shifted R value, 4R+2N[j]+N[j], is forwarded to the R register, and the “shifted t” value, which is 2t, is forwarded to the t register. If the borrow bit is not set, the R−B value (“sub result”), which equals to the shifted R value minus B, is forwarded to the R register, and the “shifted tD sum” value, which is 2t+D, is forwarded to the t register. The circuit of FIG. 4 thus performs the algorithm above when iterated for half the bitwidth of N, producing a result for x having half the bitwidth of N and a result for R having the same bitwidth as N. At the end of the iterative loop, a floor integer approximation to (N/D)^{1/2} is constructed in the x register. In certain embodiments, the constructed x value is transferred to a feedback control 540, e g., an RMS error generator 210 (FIG. 2).

It will be apparent to a person skilled in art that the hardware logic with the various logic components described above can be implemented in various ways. For example, in certain embodiments, all of the components may be discrete components placed and connected together on a printed circuit (PC) board. In other embodiments, some or all of the logic components and/or their functions can be implemented in a programmable logic array (PLA). In certain embodiments, some of the logic components and their functions can be combined into another hardware or firmware component. In certain other embodiments, the unified RMS computation algorithm can have a mixed implementation in which some parts are implemented by software while other parts are implemented by hardware logic. In certain embodiments, some or all of functions performed by a particular logic component described above can be performed by an alternative logic component. For example, the generation of a comparison value, e.g., a borrow bit, indicating whether the shifted R value is equal to or greater than B can be performed by a logical comparator rather than a subtractor.

It will be also apparent to a person skilled in the art that either the software implementation or the hardware implementation or a combination of both can be used inside various electronic systems involving an RMS computation of digitized analog signal samples. Such systems can comprise, but not limited to hardware/software-based data acquisition systems taking inputs from various sensors, telecommunications systems including cellular communications devices, and power generation and control systems including digitally-controlled power supplies.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A system for computing a Root Mean Square (RMS) value on digitized samples, the system comprising:
an analog to digital converter (ADC) configured to produce discrete digital representations of an analog signal; and
a digital computation module in data communication with said ADC and configured to:
receive said digital representations, and
compute an RMS value of said digital representations, wherein a division operation and a square root operation for said RMS computation are performed in one combined algorithm, and
a memory in data communication with said digital computation module configured to receive and store the computed RMS value.

2. The system of claim 1, wherein the digital computation module comprises a logic circuit.

3. The system of claim 1, wherein the digital computation module comprises one or more shift registers, one or more adders, and one or more multiplexers.

4. The system of claim 1, wherein the digital computation module comprises executable instructions stored in memory.

5. A method of computing a Root Mean Square (RMS) value of digitized samples, the method comprising:
producing discrete digital representations of an analog electrical signal;
computing an RMS value of said digital representations, wherein a division operation and a square root operation for said RMS computation are performed in one combined algorithm; and
outputting the RMS value.

6. A system for computing a Root Mean Square (RMS) value of digitized samples, the system comprising:
means for producing discrete digital representations of an analog electrical signal;
means for computing an RMS value of said digital representations, wherein a division operation and a square root operation for said RMS computation are performed in one combined algorithm; and
means for storing the computed RMS value.

7. A method of computing a Root Mean Square (RMS) value of digitized samples, the method comprising:
storing a total number of a plurality of digital samples as a variable D;
storing a sum of squares of said plurality of digital samples as a variable N;
using an iterative algorithm to construct a variable x having a square that is less than N/D, wherein the iterative algorithm comprises:
shifting the next two upper bits of N into a remainder variable R,
checking for maintenance of an invariant defined by values of x, R, and D, and
shifting in “1” or “0” into x depending on the result of the invariant maintenance checking.

8. The method of claim 7, wherein the invariant is derived at least partly from equation x²D+R=N and a constraint that the x is the largest integer satisfying the equation.

9. The method of claim 8, wherein the constraint is mathematically expressible as (2x+1)D>R.

10. The method of claim 8, wherein the checking comprises determining if 4 R+2N[j]+N[j−1]>=4×D+D, wherein the N[j] and the N[j−1] represent the next two bits of N shifted into R.

11. The method of claim 7, wherein the iterative algorithm terminates when the invariant maintenance checking is performed with respect to all bits of N.

12. A system for computing a Root Mean Square (RMS) value of digitized samples, the system comprising:
a first memory storing a variable D representing a total number of a plurality of digital samples;
a second memory storing a variable N representing a sum of squares of said plurality of digital samples;
a third memory storing a current remainder variable (R);
a fourth memory storing a current floor integer variable (x);
a first shift register configured to:
receive the current R from the third memory, and
generate a shifted R by shifting in the next two upper bits of N;
a comparison circuit configured to:
receive the shifted R from the first shifted register and a function B involving D and the current x, and
make a comparison between the shifted R and B; and
a second shifter register configured to:
receive the current x, and
generate a shifted x by shifting in “1” or “0” depending at least in part on the result of the comparison.

13. The system of claim 12, wherein the comparison circuit comprises a digital subtractor.

14. The system of claim 12, wherein the comparison circuit comprises a logical comparator.

15. The system of claim 12, wherein B=4xD+D.

16. The system of claim 12, wherein the system comprises no more than two multiplexers.

17. The system of claim 12, wherein the system comprises no more than five shift registers.

18. The system of claim 12, wherein the system comprises no more than two adders.

19. A power supply comprising:
power hardware having an AC power output configured for coupling to a load impedance, the AC power output configured to provide an AC output voltage and an AC output current to the load impedance;
one or more output parameter sensors;
one or more analog to digital converters configured to produce digital representations of one or more sensed output parameters; and
a digital feedback loop including a digital computation module configured to receive said digital representations and compute an RMS value of said digital representations, wherein said digital computation module is configured to perform a division operation and a square root operation for said RMS computation in one combined algorithm.

20. The power supply of claim 19, wherein the digital computation module comprises a logic circuit.

21. The system of claim 20, wherein the logic circuit is software configurable.

22. The system of claim 21, wherein the software configurable logic circuit comprises a programmable gate array.

23. The power supply of claim 19, wherein the digital computation module comprises one or more shift registers and one or more digital adder circuits and one or more multiplexers.

24. The power supply of claim 19, wherein the digital computation module comprises no more than two multiplexers.

25. The power supply of claim 19, wherein the digital computation module comprises no more than five shift registers.

26. The power supply of claim 19, wherein the digital computation module comprises no more than two adders.

27. The power supply of claim 19, wherein the digital computation module comprises executable instructions stored in memory executed by a processor.

28. A method of controlling an AC power supply, the AC power supply providing an AC output voltage and an AC output current to a load impedance, the method comprising:
sensing an output parameter;
generating digital representations of the sensed output parameter;
generating a digital control signal at least in part by computing a Root Mean Square (RMS) value of the digital representations, wherein a division operation and a square root operation for the RMS computation are performed in one combined algorithm; and
regulating one or both of the AC output voltage and the AC output current using the digital control signal.
